(19) United States
(12) Patent Application Publication
(10) Pub. No.: US 2005/0234215 A1
(43) Pub. Date: Oct. 20, 2005

(54) Segmented copoymer containing amide segments

(76) Inventors: Reinoud Jaap Gaymans, Enschede (NL); Josien Krijgsman, Deventer (NL); Debby Husken, Enschede (NL)

Correspondence Address: HOFFMANN & BARON, LLP, 6900 JERICHO TURNPIKE, SYOSSET, NY, 11791, US

(21) Appl. No.: 10/504,018

(22) PCT Filed: Feb. 20, 2003
(86) PCT No.: PCT/NL03/00130

§ 371 Date: Jun. 9, 2005

(30) Foreign Application Priority Data
Feb. 21, 2002 (EP) 020756987
Sep. 13, 2002 (EP) 020787883

(51) Int. Cl. C08G 69/08

(52) U.S. Cl. 528/310

(57) ABSTRACT

Described herein are novel amide copolymers wherein the amide segments have a length of at least three amide groups of which its length is substantially uniform and which copolymers have a glass transition temperature of less than 0° C. A copolymer according to the invention displays a fast crystallization from the melt, and a modulus that is little dependant on the temperature in the temperature region between glass transition and melting temperature. A polymer according to the invention can easily be melt processed by extrusion, injection molding and fiber spinning. A copolymer according to the inventions may be transparent, has a high fracture strain and a high elasticity.

The invention relates to a segmented copolymer containing amide segments, which has a glass transition temperature (Tg) below 0° C.

Segmented copolymers having amide segments and which have a low Tg, are well known and are used as thermoplastic elastomers (TPE) [G. Deleens, in Thermoplastic Elastomers, Editors N. R. Legge, G. Holden, H. E. Schroeder, Hanser Publisher, New York, 1987, Chapter 9B]. This means that they have a glass transition at low temperatures, are melt processable and a part of the amide segment crystallizes on cooling from the melt. The amide segments in these materials are usually based on polyamide-11 and -12, but can also be made with polyamide-6; -6,6 and -4,6 [L. C. Case, J. Polym. Sci., 29, 469, 1958; G. E. Deleens, P. Foy, E Marechal, Eur. Polym. j, 13, 337, 1980; R. J. Gaymans, P. Schwering, J. L. de Haan, Polymer, 30, 974, 1989]. The segmented copolymers with amide segments often have excellent mechanical properties, in particular good dynamic and abrasion properties. A problem with these segmented copolymers is that they have a multi phase structure and as a consequence the properties are sensitive to variations in temperature.

The temperature sensitivity is small by the use of diamide segments in the polymer [R. J. Gaymans, J. L. de Haan, Polymer, 34, 4360, 1993]. Copolymers with diamides have a transparent melt and the diamide segments crystallize fast and nearly completely on cooling; The modulus is very little dependant on temperature and the elastic properties are good [M.C.E.J. Niesten, J. Feijen, R. J. Gaymans, Polymer, 41, 8487, 2000; M.C.E.J. Niesten, R. J. Gaymans, Polymer, 42, 6199, 2001]. However, the diamide units are very short in length, which make the crystalline phase easily deformable, with as result that the elastic properties are as yet not optimal. In general one would like to have good elastic properties at a high as possible modulus. Another disadvantage of the use of the short diamide units are the relative low melting temperatures of the polymers. A high melting and flow temperature can sometimes be obtained with diamide units based on aromatic diamines [M.C.E.J. Niesten, R. Tol, R. J. Gaymans, Polymer, 42, 931, 2001]. However aromatic diamines are expensive and easily lead to colored products and should therefore be avoided as much as possible. Also the melting temperature of these polymers is very sensitive to the amide content.

It is an object of the invention to provide a novel segmented copolymer that may be used as an alternative to known polymer materials, in particular to known amide containing thermoplastic elastomers.

Accordingly the present invention relates to a copolymer, represented by formula I
—(—Y-Amide-(R-Amide-)ₙ—)ₘ— (I)
wherein each Amide represents an N(H)C(O) or C(O)N(H) group
wherein each R is independently chosen from the group consisting of alkylene moieties, alicyclic moieties and arylene moieties,
wherein n has an average value of at least about 2, preferably of at least about 3, more preferably from 3-6,
wherein m has a value of at least 1, preferably an average value of at least 2, more preferably of at least 3,
wherein 30-100 mol %, preferably 50-100 mol % and more preferably 70-100 mol % of the Amide-(R-Amide-)ₙ segments are uniform in length,
wherein the amide is based upon an aliphatic or alicyclic amine
wherein each Y represents a chain segment,
wherein the glass transition temperature of the polymer is below 0° C., preferably below −30° C.
wherein the compression set (%) is less than (10+0.5×Shear Modulus (in MPa))
wherein the tensile set (%) is less than (30×log (Shear Modulus (in MPa))+0.2)

The end groups (not shown in I) can have any structure. The end groups may for example be chosen from the group consisting of: protons, hydroxy groups, amines, acids, ester groups, groups as defined for Y and/or Amide groups.

The shear modulus (G′) as used herein is defined as the torsion modulus determined by Dynamic Mechanical Analysis (DMA) at 1 Hz and measured in a temperature sweep of 1° C./min according to DIN 53445 with the exception that 2 mm thick samples are used.

The glass transition temperature (Tg) as used herein is defined as the temperature at which the loss modulus G″ has a maximum as determined by DMA according to the above indicated modified DIN 53445 method. Unless indicated otherwise, when referred to Tg of a polymer or composition having more Tg's, the primary Tg is meant, the transition with the highest loss modulus (G″) value.

The compression set as used herein is the value as determined according to ISO 815 with the exception that the compression is 55% and the relaxation time 60 minutes.

The tensile set as used herein is the value as determined as follows: to a sample a 300% cyclic strain is applied at a strain rate of 1000%/min. A second cycle is started direct after the first cycle and the point at which in this cycle the force becomes positive again is taken as the residual strain. The tensile set (TS300%) is defined as TS300%=(residual strain/300)×100%.

The flow temperature (Tfl) as used herein is defined as the temperature at which the polymer reaches a shear modulus of 1 MPa.

The Tm as used herein is defined as the melting temperature as measurable by differential scanning calorimetry (DSC) at a scan rate of 20° C./min. For polymers, the Tm is determined in the second heating scan which is taken after first warming the sample to 20° C. above the melting temperature, cooling with 20° C./min down to 50° C. and reheating at 20° C./min. The peak maximum is taken as the melting temperature.

A copolymer according to the invention has a high uniformity. The uniformity of the amide segment (-Amide-(R-Amide-)ₙ-) is found to be important for the phase structure. It is known that very short segments are easily miscible with the Y segment and somewhat longer segments phase separate in the melt. The presence of dissolved amide segments in the Y phase increases the Tg of the Y phase and that is not wanted. Phase separated amide segments in the melt, make the synthesis more difficult, gives the polymer an extra Tg (of the polyamide phase), a broad melting transition, a slow crystallization from the melt and a low crystallinity of that segment, all of which are not wanted. By using segments with a high uniformity it has been found possible to allow a higher amide content in the polymer before melt phasing takes place. A higher amide content results in a higher melting temperature and a higher modulus. Another advantage of more uniform segments is a faster and more complete crystallization of the amide segment, which is important for the ease of processing, the effectiveness of the amide segment for increasing the modulus and the modulus sensitivity to temperature.

A copolymer according to the present invention has been found to have a modulus, which is, very little dependant on temperature in the temperature range between the Tg+30° C. and the melting temperature.

The present invention also provides a copolymer which depending on the amide concentration can have a wide range of moduli. In an embodiment the modulus (G′) at room temperature (20° C.) is between 0.1-500 MPa and preferably between 0.5-250 MPa. A copolymer with a shear modulus of less than 40 MPa, e.g with a shear modulus of 1-20 MPa, is very suitable for applications as in elastic fibers and for providing products with a “soft touch”, such as knobs, handles, switches and the like, e.g. for electric equipment, tools, casings, doors, clothing or other products that are touched by hand or skin.

In a preferred embodiment the melting temperature is at least 130° C., more preferably higher than 150° C., even more preferably higher than 180° C. A high melting temperature is important for applications were a high temperature resistance is required, like in the automotive, electrical, electronic and industrial sector. A high temperature resistance is also very important for the elastic fibers as the dying of fibers is often at high temperatures. A much preferred copolymer has both a low shear modulus of less than 20 MPa and a melting temperature of more than 150° C., or even more than 180° C.

A copolymer according to the invention has amide segments which crystallize fast on cooling from the melt. Even a polymer with a low amide (-Amide-(R-Amide-)ₙ-) content (less than 30 wt. %) is able to crystallize fast. As a result, a copolymer according to the invention is well processable, e.g. by extrusion, injection molding, blow molding and fiber spinning. A measure for the rate of crystallization is the difference between the melting temperature and the crystallization temperature (Tm-Tc) both measured by DSC at a scan rate of 20° C./min. For a polymer according to the invention that is to be processed by extrusion, injection molding or fiber spinning the Tm-Tc value is advantageously less than 50° C., preferably less than 40° C. and more preferably less than 30° C. The lower this value the faster the crystallization is and this is very important for fast processing of the materials.

A copolymer according to the invention has one or more amide segments which have a high crystallinity so that the modulus increases with concentration and said polymer is generally substantially stronger than known segmented copolymers. The amide (-Amide-(R-Amide-)ₙ-) content (wt %) depends inter alia on the desired modulus and can be less than 60 wt %, preferably less than 50 wt. % and more preferably less than 40 wt. %. For a very soft grade (G′<20 MPa) the content of amide segments is typically less than 20 wt. %.

A copolymer according to the invention shows a very favorable solvent resistance, in particular against solvents such as hydrocarbons, chlorinated hydrocarbons, petrol, alcohols, ethers, esters, ketones and the like, which is important for automotive and industrial uses.

A copolymer according to the invention shows a good resistance against detrimental influences of inorganic salts, which is for example advantageous when such a polymer is used in an automotive application, because of the possible exposure to salt that has been used to grit roads.

The melting temperature for the polymers according to the invention is much sharper than for a polymer wherein the distribution of the amide segment length is random. This is found to be an advantage in the melt processing of the materials.

Surprisingly it has been found that a copolymer according to the invention has a very low compression set compared to known amide-TPE materials both at room temperature and high temperatures. The compression set at 20° C. as function of the shear modulus at 20° C. is less than (10+0.5×Shear Modulus (in MPa)).

A copolymer according to the invention has shown to have very favorable tensile elastic properties. In particular, it has been found that in a preferred embodiment a copolymer according to the invention has a tensile set (TS300%) in a cyclic deformation test after 300% strain, of less than (30 log (shear modulus (in MPa))+0.2).

A polymer according to the invention has these good elastic properties both on unoriented and oriented samples.

A polymer according to the invention has a has a high fracture strain and/or a high elasticity. In particular, a polymer displays a homogeneous deformation on straining and a high elongation at break value. The absence of strain softening with the large fracture strain means that the polymer has a ductile deformation behavior and a high fracture energy.

Surprisingly it has been found that, despite a copolymer according to the invention being semi-crystalline—it may still be transparent. Transparency is for many applications a highly valued property.

As can be understood from the properties indicated above, a copolymer according to the invention may have a variety of favorable properties. Thus, the present invention provides a range of polymers, which depending upon their specific properties, may be employed in a variety of application areas, including e.g. automotive (boots, safety hatches, seals, headlight housing), consumer (snow boards, ski shoes, springs, in-line skates), electrical/electronic (protective coverings, water seals) and industrial (low noise gears, pumps, conveyer belts). A copolymer can also be used for fiber applications and for overmoulding. A polymer may also be used as (impact) modifier in blends, such as polyamides, polyesters, polyethylene, polypropylene, polyurethanes, polyacetal, polycarbonate, polystyrene, polycarbonate, poly(phenylene ether), polyesterethers, polyurethanes, polyureas, SBS, SEBScopolymers, PP-EPDM/EPR, PP-EPDM/EPR dynamic vulcanizates, rubbers and/or copolymer and blends of these polymers.

In a preferred embodiment, at least a major part of the amide segments is formed of tri-amide segments (n=2) or of tetra-amide segments (n=3). Very suitable polymers according to the invention are polymers wherein the amide segments Amide-(R-Amide-)ₙ are chosen from the group consisting of
—C(O)N(H)—R₂—N(H)C(O)—R₃—N(H)C(O)—;
—N(H)C(O)—R₁—C(O)N(H)—R₃—C(O)N(H)—
—C(O)N(H)—R₂—N(H)C(O)—R₁—C(O)N(H)—R₂—N(H)C(O)—;
—C(O)N(H)—R₃—C(O)N(H)—R₂—N(H)C(O)—R₃—N(H)C(O)—;
—N(H)C(O)—R₁—C(O)N(H)—R₂—N(H)C(O)—R₁—C(O)N(H)—
—N(H)C(O)—R₃—N(H)C(O)—R₁—C(O)N(H—)—R₃—C(O)N(H)—,
   wherein each R₁, is independently chosen from the group consisting of alkylene moieties, alicyclic moieties and arylene moieties and each R₂ and R3 is independently chosen from the group consisting of alkylene moieties and alicyclic moieties.

Preferably at least the majority of R₁ are independently chosen from the group consisting of C₁-G₂₀ alkylene, C₄-C₂₀ alicyclic moieties and C₆-C₂₀ arylene moieties. Much preferred alkylene moieties are C₂-C₈ alkylene moieties. Much preferred arylene moieties are C₆-C₁₂ arylene moieties. Much preferred alicyclic moieties are C₆-C₁₂ alicyclic moieties.

In a preferred embodiment at least the majority of the R₁'s are independently chosen from the group consisting of adipic acid residues, terephthalic acid residues, isophthalic acid residues and naphthalic acid residues.

Preferably at least the majority of R₂ and/or R₃ are independently chosen from the group consisting of C₁-C₂₀ alkylene and C₄-C₂₀ alicyclic moieties. Much preferred alkylene moieties are C₂-C₈ alkylene moieties. Much preferred alicyclic moieties are C₆-C₁₂ alicyclic moieties. The alkylene and alicyclic moieties may contain arylene groups.

Very suitable is a copolymer wherein at least the majority of the alkylene moieties are linear alkylene moieties, e.g. linear C₁-C₂₀ alkylene, preferably linear C₂-C₈ alkylene.

Preferably at least one chain segment Y is a diacid chain segment made of an acid end modified aliphatic, aromatic, or partially aromatic polymeric segment, wherein the polymeric segment is a polyolefin, polyether, polyester, polycarbonate, polysilane, polysiloxanes, polyacrylate or a copolymeric segment comprising moieties selected from the group consisting of olefin moieties, ether moieties, ester moieties, carbonate moieties, acrylate moieties, silane moieties, siloxanes moieties and styrene moieties. If these polymeric segment contain hydroxyl groups than these segments can be reacted with a diacid or diacid derivative to a diacid chain segment.

In an other preferred embodiment at least one chain segment Y is a diamine chain segment made of an amine end modified aliphatic, aromatic, or partially aromatic polymeric segment, wherein the polymeric segment is a polyolefin, polyether, polyester, polycarbonate, polysilane, polysiloxanes, polyacrylate or a copolymeric segment comprising moieties selected from the group consisting of olefin moieties, ether moieties, ester moieties, carbonate moieties, acrylate moieties, silane moieties, siloxanes moieties and styrene moieties.

One or more polymeric segments Y in a polymer according to the invention may comprise one or more polyethers. Suitable polyethers as polymeric segment Y include segments that comprise poly(tetramethyleneoxide) (PTMO), polypropyleneoxide (PPO), polyethyleneoxide (PEO), polypentamethyleneoxide, or copolymers of any of these polymers. Suitable polyesters include aliphatic polyesters such as poly(hexylene adipate), poly(butylene adipate), polypropylene adipate), poly(ethylene adipate). Also segments comprising acrylic acid, acrylester, styrene, functionalized polystyrene, unsaturated polyols, functionalized polyolefin's like C36-diacid (Uniquema), C36-diol (Uniquema), this for hydroxyl, amine, ester or acid functionalized segments. Also maleic anhydride modified polybutylene, polyisoprene, natural rubber, polyethylene, poly(ethylene-butylene) copolymers, polyethylene copolymers, poly(ethylene-propylene) copolymer, EPDM, SBS and SEBS. Instead of maleic anhydride groups the segments might contain also other acid, anhydride, amine, and hydroxyl groups.

In a preferred embodiment at least part of the Y segments are selected from the group consisting of polyvinylalcohol segments, polyalkyleneoxide segments (e.g. PTMO, PPO, PEO), aliphatic polyester segments, polysiloxanes segments, poly(ethylene-butylene) segments, C36 segments and acrylic acid polymer segments. In particular a copolymer comprising one or more of these types of segments has been found to combine a low glass transition temperature with a high melting temperature.

For applications wherein a “soft touch” is desired, a copolymer wherein Y at least consists of one or more segments selected from the group consisting of polyether-, aliphatic polyester-, polycarbonate-, polysiloxanes-, poly(ethylene-butylene)-, polybutylene-segments has been found to be particularly suitable.

A polymer according to the invention may comprise one or more chain segments Y that are extended with an ester, polyester, carbonate, polycarbonate, epoxy, poly(epoxy), imide, polyimide or the like.

A polymer according to the invention may comprise in the Y segment polyfunctional units like tri and tetra units, leading to some degree of branching and cross-linking. With these units the compression set properties are improved.

Good results have been achieved with a polymer wherein Y is an extended flexible chain segment such as; polyethers extended with esters like terephthalic or isophthalic groups and or polyesters like poly(ethylene terephthalate) and poly(butylene terephthalate). Preferred flexible chain segments include poly(tetramethylene oxide), poly(propylene oxide), poly(ethylene oxide), poly(tetramethylene adipate), polycarbonate, poly(ethylene/butylene), poly(dimethylsiloxane), polycarbonate, polyolefin. For example a polyether segment with hydroxyl end groups can react with a diacid or diacid derivatives to higher molecular weight segment and very good results have been obtained with a polytetramethyleneoxide extended with terephthalic or isophthalic acid derivative to a higher molecular weight segment resulting in polymers with a very low modulus and excellent elastic properties like tensile set and compression set. This extending of the segments in Y might take place before, after or at the same time as the amide segments are coupled to the other segment.

The segments might be coupled to the amide segments by several types of units, like ester, polyester, carbonate, polycarbonate, epoxy, epoxy polymer, imide and polyimide. These Y segments with functional groups may be prepared first or can be formed during the polymerization process.

Very good results have been achieved with a polymer wherein at least the majority of the segments Y have a molecular weight in the range of 45-40,000 g/mol, preferably 200-20,000 g/mol. In a much preferred embodiment at least the majority of the segments Y have an molecular weight in the range of 500 to 20,000 g/mol. Very suitable is a copolymer wherein at least the majority of the segments Y have a molecular weight of at least 1,000 g/mol. Very good results have been achieved with a copolymer wherein at least the majority of the segments Y have a molecular weight of more than 4,000 g/mol.

The size of a polymer according to the invention may—depending upon its intended use—be chosen within a wide range. For example the number average molecular weight (Mn) of the polymer may be in the range of 1,000 g/mol to 1,000,000 g/mol. Preferably, Mn is approximately 2,000 g/mol to 100,000 g/mol.

A copolymer according to the invention may in principle be prepared in any way. For example the Amide-(R-Amide-)ₙ segments may be prepared in a condensation reaction, e.g. by reacting diacids with diamines, by reacting polyaminoacids, or by reacting aminoacids with either a diacid or diamine. In this way polyamide segments are formed wherein n is 2-6. Polymers are prepared with these polyamide segments and units that form Y segments in the polymer.

In a preferred embodiment the whole Amide-(R-Amide-)ₙ segment is prepared first, and then a copolymer is formed with a compound providing segment Y. This gives the possibility to obtain a copolymer with a high uniformity of the length of the amide segments. For example a tetra-amide segment with ester end groups can be reacted with a Y segment containing hydroxyl end groups and extending terephthalic groups in the chain.

In another preferred embodiment the starting amide segment is shorter than the final length and in the polymerization reaction the final amide length is formed. Shorter amide segments are more easily prepared and have a lower melting temperature. For example a di-amide with amine end groups can be reacted with a compound Y having (or yielding) ester end groups. In the course of reaction amide segments of a suitable length, e.g. tetra-amides, are formed. For example a polyether with hydroxyl end groups can react with a diester functionalized tetra-amide. However it is also possible to react a polyether with hydroxyl endgroups with a diacid like terephthalic acid or diacid derivative and a diamine-diamide to form in the course of reaction the tetra-amide segments in the polymer. As diacid derivative several options are possible: e.g. monomethylester acid, dimethylester, monophenylester acid, methylphenylester, diphenylester, monomethylester monoacid chloride, diacid chloride and also dimethylester and water resulting in monomethylester acid. The advantage of this last route is that it can be a “one pot” synthesis.

Good results have been achieved with a polymer wherein the amide segment is made from a diamine and a diacid and used in the polymerization reaction without first isolating the amide compound. For example a diamine can be reacted with an acid compound forming an amide which react with a compound Y. In the course of reaction amide segments of a suitable length, e.g. tetra-amides, are formed. Preferably a mixture of acid compounds are use for this reaction with different reactivities. As diacid derivative several options are possible: e.g. monomethylester acid, dimethylester, monophenylester acid, methylphenylester, diphenylester, monomethylester monoacid chloride, diacid chloride and also dimethylester and water resulting in monomethylester acid. The advantage of this last route is that it can be a “one pot” synthesis. It is also possible to form the methylphenylester and diphenyl ester from terephthalic acid, monomethylester acid and/or dimethylester with diphenyl carbonate.

The polymerization can be carried out with a solvent or without a solvent. The last step of the polymerization process is in the melt. In order to attain higher molecular weights a post condensation in the solid state is possible.

Examples of suitable diacids, diamines, respectively amino acids are HOOC—R₁—COOH, H₂N—R₂—NH₂, respectively H₂N—R₃—COOH, wherein R₁, R₂, respectively R₃ are as identified above.

As a polymer according to the invention crystallizes fast from the melt it is very easily processable, particular by extrusion and injection molding. The markets for these materials are e.g. automotive (boots, safety hatches, seals, headlight housing), consumer (snow boards, ski shoes, springs, in-line skates), electrical/electronic (protective coverings, water seals) and industrial (low noise gears, pumps, conveyer belts).

The polymer is also very suitable for overmoulding of an other polymer part made of polyamide, polyester, polypropylene, polyacetal, polystyrene, polycarbonate, polyphenylene ether.

A polymer may also very suitably be employed in co-extrusion with one or other polymers, such as polyamides, polyesters, polyethylene, polypropylene, polyurethanes, polyureas, polyacetal, polycarbonate, polystyrene, polycarbonate, polyphenylene ether), and/or copolymer and combinations thereof.

A polymer according to the invention is strongly orientable and may very suitably be used for manufacturing fibers with good properties, such as high elasticity, strong strain hardening, high fracture stress, high fracture strain and a high melting temperature. A fiber from a polymer according to the invention may be used in textiles (e.g. for the manufacture of garments where comfort and fit are desired: hosiery, swimsuits, aerobic/exercise wear, ski pants, golf jackets, disposable diaper, waist bands, bra straps and bra side panels). These fibers can also be used in compression garments: surgical hose, support hose, bicycle pants, foundation garments and in shaped garments like bra cups.

A very suitable copolymer for the manufacture of a fiber is a copolymer according to the invention, having a tensile set (TS300%) of less than 20% (measured as is indicated above) and a melting temperature of more than 150° C., preferably more than 180° C. Such a polymer has been found to be very appropriately processable by melt spinning.

The copolymer might also contain an unmodified polymer Y, with which it is blended.

A polymer according to the invention may also very suitably be employed in breathable films, in membranes and in bio-compatible materials. Particular polymers containing Y segments that consist mainly of polyethylene oxide (PEO) are very suitable for this as they combine a hydrophilic nature with good elastic properties.

The properties of the polymer according to the invention usually improve by increasing molecular weight. A side effect of higher molecular weight materials is a higher melt viscosity and a lower crystallization rate. A low molecular weight material has a very low melt viscosity that is good for processability but poor for the elastic properties. It has now been found that if a low molecular weight polymer is made with less Y segments compared to amide segments, with as consequence that the majority of the end groups are amide groups, they have a low viscosity and surprisingly this combined with excellent elastic properties like compression set.

The invention further relates to a composite comprising a polymer according to the invention, preferably a polymer of which at least the majority of the amide segments are tri-amides and/or tetra-amides (i.e. wherein n=2, respectively n=3). Particular suitable are composites comprising a polymer according to the invention with reinforcing fillers like mica, kaolin, calcium carbonate, glass fiber, aramide fiber, carbon fiber and the like.

A polymer according to the invention may be employed as such or in a composition further comprising one or more fillers, fibers, colorants, oils, antioxidants and/or other additives typically employed in polymer materials.

A copolymer according to the invention may also be used in combination with an oil. Such a composition may for example be suitable for soft touch applications like: shavers, screwdrivers, tooth brushes.

The invention will now further be illustrated by the following examples.

### EXPERIMENTAL

Segmented copolymers with the tetra-amide TXTXT hard segments and an aliphatic polyether like poly(tetramethylene oxide) (PTMO) as soft segments were made in a polycondensation reaction. The T stands for a terephthalic unit and the X for a diamine species. Polymers were prepared with compounds TXTXT and XTX. The XTX material, a diamine-diamide of terephthalic acid was synthesized from dimethyl terephthalate (DMT) and an excess of diamine in the melt. The XTX could be purified by recrystallization. The TXTXT compound was synthesized from XTX with an excess of methyl phenyl terephthalate (MPT) to obtain the product TXTXT having methyl ester endgroups (TXTXT-dimethyl).

The inherent viscosity (ηᵢₙₕ) of the polymers was determined at a concentration of 0.1 dl/g in a 1:1 (molar ratio) mixture of phenol/1,1,2,2-tetrachloroethane at 25° C., using a capillary Ubbelohde 1B (ASTM D446). ¹H NMR spectra were recorded on a Bruker AC spectrometer at 300 MHz using trifluoro acetetic acid (TFA) as a solvent.

The uniformity of the 6T6 product was determined by ¹H-NMR from the methylene protons at the amide side at 3.69 ppm and methylene protons at amine side at 3.31 ppm. The ratio (R) [methylene amide side at 3.69/methylene amine side at 3.31] (R_{3.69/3.31}) was 1.0 for 6T6 and 2.0 for 6T6T6. The uniformity was approximated by [2−(R_{3.69/3.31})×100%].

The uniformity of the T6T6T product was determined by ¹H-NMR from integral of the terephthalic protons on the amide side at 7.93-7.98 ppm and the protons on the terephthalic ester side at 8.28 ppm. The ratio (R) [terephthalic protons on the amide side/terephthalic ester side] (R_{7.93-7.98/8.28}) is for T6T6T 2.0 and for T6T6T6T 3.0. The uniformity of T6T6T is approximated by [3−(R_{7.93-7.98/8.28})×100%].

The uniformity of the T6T6T segment in the polymer was determined by ¹H-NMR from integral of the terephthalic protons on the amide side at 7.93-7.98 ppm and the protons on the terephthalic ester side at 8.28 ppm. The ratio (R) [terephthalic protons on the amide side/terephthalic ester side] (R_{7.93-7.98/8.28}) is for T6T6T 2.0 and for T6T6T6T 3.0. The uniformity of T6T6T is approximated by [3−(R_{7.93-7.98/8.28})×100%]

The Amide content is calculated on the basis of the -Amide-(R-Amide)ₙ- content in the —(—Y-Amide-(R-Amide)ₙ-)ₘ-.

Samples for the dynamical mechanical analysis (DMA) test (70×9×2 mm) were prepared on an Arburg H manual injection moulding machine. Before use, the samples were dried in a vacuum oven at 70° C. overnight. Using a Myrenne ATM3 torsion pendulum at a frequency of approximately 1 Hz the values of the storage modulus G′ and the loss modulus G″ as a function of the temperature were measured according to DIN 53445 with the exception that 2 mm thick samples were used. The glass transition temperature (Tg) was expressed as the temperature where the loss modulus G″ has a maximum. The flow temperature (Tm) was defined as the temperature where the storage modulus G′ reached 1 MPa. The storage modulus of the rubber plateau is determined at room temperature (G′₂₀).

To measure the compression set, a piece of an injection moulded test bar was placed between two steel plates and compressed to 1 mm (˜55% compression). After 24 hours at 20° or 70° C. the compression was released. One hour later the thickness of the sample was measured. The compression set was defined as:

$$Compression set = \frac{{d}_{0} - {d}_{2}}{{d}_{0} - {d}_{1}} \times 100 \% \qquad eq . 1$$

d₀=thickness before compression [mm], d₁=thickness during compression [mm], d₂=thickness one hour after release of compression [mm]. For the 20° and 70° C. test the compression set is abbreviated as respectively CS₂₀ and CS₇₀.

Samples for the tensile tests were prepared by melt extruding the polymers into threads on a 4 cc DSM res RD11H co-rotating twin screw mini extruder. The extruder temperature was approximately 60° C. above the flow temperature, and the screw speed was 30 rpm. The threads were winded at a speed of 33 m/min. The density of the polymers was approximately 1.0 g/cm³.

Tensile tests were carried out on a Zwick Z020 universal tensile machine equipped with a 10 N load cell. The strain was measured as the clamp displacement. Stress-strain curves were obtained at a strain rate of 250 mm/min with a starting clamp distance of 25 mm. Cyclic tensile tests were done at a straining rate of 200 mm/min with a starting clamp distance of 50 mm. Until 100% strain, the strain increased 20% each cycle, followed by a strain increase of 100% each cycle until the sample broke. The tensile set was measured in a cyclic test to 300% strain. The residual strain (strain where the force becomes positive again) in the second cycle was determined. TS_{300%} was defined as:

$${TS}_{300 \%} = \frac{residual strain}{300} \times 100 \% \qquad eq . 2$$

### EXAMPLE 1

### Preparation diamino-diaamide (6T6-diaamine)

Di-(6-aminohexyl)terephthalamide (DAHT or 6T6-diamine) was made in a 1 L stirred round bottom flask with nitrogen inlet and a reflux condenser loaded with 38.8 g DMT (0.20 mol) and 139 g 1,6-diaminohexane (1.2 mol). The mixture was heated to 120° C. and kept at that temperature for 2 hours. At 80° C. a clear solution was formed and methanol started boiling off. When the temperature of 120° C. was reached, precipitation had caused solidification of the reaction mixture. After 2 hours 500 ml m-xylene was added and the mixture was stirred for 15 minutes. The suspension was filtered with a hot glass filter and washed with boiling toluene. The product was washed with toluene. The product was washed with toluene, diethylether and dried. The yield was 91%, the uniformity 70% and the melting temperature 170° C.

The so obtained 6T6 can be recrystallized from n-butylacetate (15 g/liter, 110° C.). The uniformity after recrystallization was 95% and the melting temperature 180° C.

Preparation diester-tetra-amide (T6T6T-diester)

T6T6T-dimethyl was made in a 1 L stirred round bottom flask with nitrogen inlet and a reflux condenser loaded with 7.24 g purified 6T6-diamine (0.02 mol), 20.5 g MPT (0.08 mol) and 400 ml NMP. The mixture was warmed to 120° C. and kept at that temperature for 16 hours. After cooling, the precipitated product was filtered with a glass filter and washed with NMP, toluene and acetone. The yield of the reaction was 80%, the uniformity >95% and the Tm 303° C. as measured by DSC.

Polymerization (T6T6T-PTMO₂₀₀₀)

The polymers of T6T6T-dimethyl with poly(tetramethylene oxide) (PTMO) with an average molecular weight of 2000 g/mol (PTMO₂₀₀₀) were made in a polycondensation reaction. The reaction was carried out in a 50 ml glass flask with a nitrogen inlet and mechanical stirrer. The vessel, containing T6T6T-dimethyl (3.43 g, 0.005 mol) with a purity of 95%, PTMO₂₀₀₀ (10.00 g, 0.005 mol), Irganox 1330 (0.1 g), catalyst solution (0.5 ml of 0.05M Ti(i-OC₃H₇)₄ in m-xylene) and 25 ml NMP, was heated in an oil bath to 180° C. After 30 minutes reaction time, the temperature was raised to 220° C. and after 30 minutes to 280° C. and maintained for two hours. The pressure was then carefully reduced (P<20 mbar) and then further reduced (P<1 mbar) for 60 minutes. Finally, the vessel was allowed to cool to room temperature whilst maintaining the low pressure. The polymer was extracted and cut to pieces. The so obtained segmented copolymers (T6T6T-PTMO₂₀₀₀) with an amide content of 15.0%, had an inherent viscosity of 2.2 dl/g, glass transition temperature of −70° C., a flow temperature of 226° C. and a shear modulus at 20° C. (G′₂₀) of 34 MPa. The compression set CS₂₀ was 14% and the CS₇₀ 36%.

### EXAMPLE 2

Copolymer (T6T6T-PTMO₂₉₀₀) was made from T6T6T-dimethyl as described in example 1 and PTMO with a molecular weight of 2900 g/mol (PTMO₂₉₀₀) according to example 1, however, with a final polymerization temperature at 250° C. The copolymer with an amide content of 11.1%, was transparent had an inherent viscosity of 2.7 dl/g, an uniformity of the T6T6T groups of 93%, a Tg at −70° C. a Tfl at 217° C. and a G′₂₀ of 17 MPa. The CS₂₀ was 9% and the CS₇₀ 27%.

### EXAMPLE 3

Copolymers (T6T6T-(PTMO₁₀₀₀-T)ₓ) were made from T6T6T-dimethyl, DMT and PTMO with a molecular weight of 1000 g/mol (PTMO₁₀₀₀). DMT is an extender for the PTMO₁₀₀₀ and in this way the soft segment length can be increased. By increasing the DMT content the (PTMO₁₀₀₀-T), molecular weight increases and T6T6T content decreases. The x stands here for the molecular weight of (PTMO₁₀₀₀-T). For example for T6T6T-(PTMO₁₀₀₀-T)₆₀₀₀ with a molecular weight (PTMO₁₀₀₀-T) of about 6000 the procedure was as follows. To a 50 ml reaction vessel with nitrogen inlet and mechanical stirrer was charged PTMO₁₀₀₀ (13.566 mmol), DMT (11.066 mmol), T6T6T-dimethyl (2.5 mmol), 25 ml NMP, 0.14 gr Irganox 1330 and 1.36 ml catalyst solution (0.5 ml of 0.05M Ti(i-OC₃H₇)₄ in m-xylene). The polymerization procedure was as described in example 1, with a final polymerization temperature at 250° C. The T6T6T used for this synthesis had a uniformity of 95%.

Several polymers were made in this way and are given in Table 1. The polymers were transparent and had all an inherent viscosity of >2 dl/g. The polymers could be injection molded into bars and extruded into treads. Thermal and mechanical properties of both injection molded samples and extruded treads are given in Table 1. The copolymers with a very low amide content combine a low glass transition temperature with a high melting temperature, a very low modulus and a very high elongation at break and a high elasticity.

TABLE 1
Properties of the T6T6T-(PTMO₁₀₀₀/DMT)x polymers.

| | Amide | | | | | | | | |
|---|---|---|---|---|---|---|---|---|---|
| | cont. | ηᵢₙₕ | T_{g} | T_{fl} | G′₂₀ | σ_{b} | ε_{b} | CS₂₀ | TS_{300%} |
| Polymer | [wt %] | [dl/g] | [° C.] | [° C.] | [MPa] | [MPa] | [%] | [%] | [%] |
| T6T6T-(PTMO₁₀₀₀-T)₃₀₀₀ | 10.7 | 3.1 | −61 | 225 | 15 | 42 | 1190 | 10 | 19 |
| T6T6T-(PTMO₁₀₀₀-T)₄₀₀₀ | 8.0 | 2.3 | −61 | 208 | 9 | 20 | 1350 | 8 | 13 |
| T6T6T-(PTMO₁₀₀₀-T)₆₀₀₀ | 5.3 | 2.6 | −61 | 200 | 7 | 25 | 1890 | 9 | 8 |
| TGT6T-(PTMO₁₀₀₀-T)₈₀₀₀ | 4.0 | 2.2 | −63 | 190 | 6 | 20 | 1900 | 7 | 6 |
| T6T6T-(PTMO₁₀₀₀-T)₁₀₀₀₀ | 3.2 | 2.5 | −63 | 183 | 5 | 31 | 1740 | 7 | 5 |

### EXAMPLE 4

Copolymers (T6T6T-(PTMO₁₀₀₀-T)ₓ) were made from T6T6T-dimethyl, DMT and PTMO₁₀₀₀ with the polymerization procedure as described in example 3, with a final polymerization temperature at 250° C. The T6T6T-dimethyl used for this synthesis had a uniformity of 80%. The polymers had all an inherent viscosity of >1 dl/g. (Table 2). The polymers could be injection molded into bars and extruded into threads (fibers). The thermal and mechanical properties of both injection molded samples and extruded treads are given (Table 2). The copolymers combine a low glass transition temperature with a high melting temperature, a very low modulus and a very high elongation at break and a high elasticity.

TABLE 2
Properties of the T6T6T-(PTMO₁₀₀₀/DMT)x polymers.

| | Amide | ηᵢₙₕ | T_{g} | T_{fl} | G′₂₀ | E | σ_{y} | σ_{b} | ε_{b} |
|---|---|---|---|---|---|---|---|---|---|
| Polymer | [wt %] | [dl/g] | [° C.] | [° C.] | [MPa] | [MPa] | [MPa] | [MPa] | [%] |
| T6T6T-(PTMO₁₀₀₀-T)₃₀₀₀ | 10.7 | 1.4 | −60 | 242 | 24 | 95 | 5.3 | 24 | 1250 |
| T6T6T-(PTMO₁₀₀₀-T)₄₀₀₀ | 8.0 | 1.5 | −61 | 240 | 14 | 61 | 3.9 | 23 | 1370 |
| T6T6T-(PTMO₁₀₀₀-T)₆₀₀₀ | 5.3 | 1.9 | −61 | 210 | 7 | 38 | 2 | 34 | 1570 |

ηᵢₙₕ = inherent viscosity,
E = E-modulus,
σ_{y}: yield stress,
σ_{b}: fracture stress,
ε_{b}: fracture strain

The elastic properties of these polymers are given in Table 3. The compression set was measured at 20° C. and 70° C. TS_{300%} was determined on the as spun material as after drawing.

TABLE 3
Compression set and tensile set for T6T6T-PTMO₁₀₀₀/DMT polymers.

| | Amide | | | TS_{300%} [%] | | | | |
|---|---|---|---|---|---|---|---|---|
| | cont. | CS₂₀ | CS₇₀ | as spun | ε | ε | ε | ε |
| Polymer | [w %] | [%] | [%] | ε = 0% | 300% | 500% | 750% | 1000% |
| T6T6T-(PTMO₁₀₀₀-T)₃₀₀₀ | 10.8 | 12.0 | 24 | 19.5 | 16.5 | 17.2 | 18.8 | — |
| T6T6T-(PTMO₁₀₀₀-T)₄₀₀₀ | 8.0 | 7.8 | 21 | 11.5 | 9.0 | 8.7 | 11.1 | 12.0 |
| T6T6T-(PTMO₁₀₀₀-T)₆₀₀₀ | 5.3 | 7.5 | 20 | 7.0 | 5.0 | 4.8 | 5.1 | 5.8 |

TS_{300%} = tensile set, measured in a cyclic test up to 300% strain (at the amount of pre-drawing ε = 0-1000%)

### EXAMPLE 5

The copolymer (T6T6T-(PTMO₁₀₀₀-I)₆₀₀₀) was made from T6T6T-dimethyl, dimethyl isophthalate (DMI) and PTMO₁₀₀₀. DMI is an extender for the PTMO₁₀₀₀ and in this way the soft segment (PTMO₁₀₀₀-I) length was increased to about 6000 g/mol. The polymerization procedure was as described in example 3, with a final polymerization temperature at 250° C. The used T6T6T-dimethyl had a uniformity of 95%. The polymer was transparent, had an inherent viscosity of 2.2 dl/g, a Tg of −60° C., a Tfl of 198° C., a shear modulus G′₂₀ of 6 MPa, a CS₂₀ of 5% and a CS₇₀ of 27%.

Using DMI compared to DMT as extender of the PTMO phase gave very similar thermal properties and excellent elastic behavior.

### EXAMPLE 6

Bisester-tetramides (TXTXT-dimethyl) were made from a diamide and DMT according to the procedure given in example 1. From the diamine and DMT with a 6 fold excess diamine the diamine-diamide (XTX) were made first, and the results of these synthesis are given in table 4.

TABLE 4
XTX synthesis from a diamine and DMT

| | temp | time | yield | uniformity | yield* | uniformity* |
|---|---|---|---|---|---|---|
| Diamine | (° C.) | (h) | (%) | (%) | (%) | (%) |
| ethylene | 60 | 5 | 83 | 69 | 51 | 99 |
| propylene | 80 | 4 | 97 | 78 | 8 | 96 |
| butylene | 100 | 4 | 77 | 84 | 11 | 96 |
| hexylene | 120 | 2 | 91 | 70 | 40 | 97 |
| octylene | 160 | 4 | 76 | 93 | — | — |

*after recrystallization

TXTXT-dimethyl was synthesized from XTX (table 4) and methyl phenyl terephthalate (MPT) according to the method given in example 1. Results are given in Table 5.

TABLE 5
TXTXT-dimethyl synthesized from XTX and MPT

| diamine | | | | TXTXT | TXTXT |
|---|---|---|---|---|---|
| in | XTX uniformity | temp | time | yield | uniformity |
| XTX | (%) | (° C.) | (h) | (%) | (%) |
| ethylene | 99 | 125 | 5 | 74 | 97 |
| propylene | 96 | 120 | 16 | 43 | 98 |
| butylenes | 96 | 120 | 5 | 71 | 97 |
| hexylene | 97 | 120 | 16 | 80 | 97 |
| octylene | 93 | 120 | 5 | 73 | 93 |

Copolymers were made from T6T6T-dimethyl, DMT and PTMO₁₀₀₀. With these TXTXT-dimethyl, PTMO₁₀₀₀ and DMT are polymers synthesized as in example 3 and the results are given in table 6.

TABLE 6
TXTXT-(PTMO₁₀₀₀/DMT)₆₀₀₀ copolymers with different diamines

| | temp | ηᵢₙₕ | T_{g} | T_{fl} | G′₂₀ | CS₂₀ | CS₇₀ |
|---|---|---|---|---|---|---|---|
| Amide segment | (° C.) | (dl/g) | (° C.) | (° C.) | (MPa) | (%) | (%) |
| T2T2T | 280 | 2.48 | −60 | 245 | 6 | 8 | 44 |
| T3T3T | 280 | 3.02 | −65 | 173 | 3 | 6 | 33 |
| T4T4T | 280 | 2.54 | −60 | 230 | 5 | 7 | 24 |
| T6T6T | 250 | 2.6 | −61 | 200 | 6 | 6 | 25 |
| T8T8T | 250 | 3.4 | −60 | 189 | 5 | 5 | 33 |

The type of diamine in the TxTxT influences the Tfl most strongly. All these polymers had a high modulus and excellent elastic properties, for their amide concentration (about 5-6%).

### EXAMPLE 7

Copolymers T6T6T-(PTMO₁₀₀₀/T)₆₀₀₀ were made from 6T6, a terephthalic acid derivate and PTMO₁₀₀₀. The 6T6 used had a purity of 97%.

The vessel, contained 6T6 (0.891 g, 2.5 mmol), PTMO₁₀₀₀ (13.566 g, 13.566 mmol), terephthalate (15.066 mmol), Irganox 1330 (0.12 g), catalyst solution (1 ml of 0.05M Ti(i-OC₃H₇)₄ in m-xylene) and 25 ml NMP. The reaction mixture was heated to 120° C., kept at that temperature for 2 hours, then warmed in 1 hour to 250 and kept 2 h at 250. The pressure was then carefully reduced (P<20 mbar) and then further reduced (P<1 mbar) for 60 minutes. Finally, the vessel was allowed to cool to room temperature whilst maintaining the low pressure.

These polymers were synthesized with the terephthalic compounds dimethyl terephthalate (DMT), diphenyl terephthalate (DPT) and methyl phenyl terephthalate (MPT). The results of these polymerisations are given in table 7.

TABLE 7
T6T6T-(PTMO₁₀₀₀/T)₆₀₀₀ starting from 6T6 and a terephthalic
compound

| Terephthalic | ηᵢₙₕ | | | G′₂₀ | CS₂₀ | CS₇₀ |
|---|---|---|---|---|---|---|
| compound | (dl/g) | T_{g} (° C.) | T_{fl} (° C.) | (MPa) | (%) | (%) |
| DMT | 1.3 | — | — | — | — | — |
| DPT | 2.7 | −65 | 194 | 5 | 6 | 40 |
| MPT | 2.7 | −60 | 195 | 5 | 6 | 30 |
| DMT/MPT | 2.2 | −65 | 192 | 7 | 6 | 37 |
| (3:1) | | | | | | |

Synthesizing TXTXT polymers starting from XTX materials results in polymers with excellent thermal and mechanical properties.

### COMPARATIVE EXAMPLE

Polymerized were hexamethylenediamine (HMDA), DMT and PTMO₁₀₀₀ and the concentrations of HMDA and DMT were chosen such that T6T6T-(PTMO₁₀₀₀-T)₆₀₀₀ could be made. The vessel, contained HMDA (0.580 g, 5.0 mmol), PTMO₁₀₀₀ (13.566 g, 13.566 mmol), DMT (3.601 g, 18.566 mmol), Irganox 1330 (0.12 g), catalyst solution (1 ml of 0.05M Ti(i-OC₃H₇)₄ in m-xylene) and 25 ml NMP. The reaction mixture was heated to 120° C., kept at that temperature for 2 hours, then warmed in 1 hour to 250, kept 2 h at 250 during which time most of the NMP distilled off. The pressure was then carefully reduced (P<20 mbar) to distill off the last NMP and then further reduced (P<1 mbar) for 60 minutes. Finally, the vessel was allowed to cool to room temperature whilst maintaining the low pressure. The so obtained polymer was still a liquid at room temperature and had an ηᵢₙₕ of 0.7.

### EXAMPLE 8

The polymer T6T6T-(PTMO₁₀₀₀/T)₆₀₀₀ was synthesized by first making the T-(PTMO₁₀₀₀-T)₆₀₀₀. This T-(PTMO-T)₆₀₀₀ was then reacted with 6T6 to a high molecular weight polymer. A mixture on PTMO₁₀₀₀ (10.85 g, 10.85 mmol), DPT (4.086 g, 12.85 mmol), 0.10 g Irganox and 1.28 ml of catalyst solution catalyst solution (0.05M Ti(i-OC₃H₇)₄ in m-xylene) were charged to a 50 ml reaction vessel with a nitrogen inlet and mechanical stirrer. The reaction mixture was warmed in 1 hour to 250° C., kept 1 hour at 250° C. and then cooled to 120° C. To this viscous liquid is charged a solution of 6T6 (2.0 mmol) in NMP (20 ml) having a temperature of 120° C. This mixture is warmed in 1 hour to 250° C., kept 1 hour at 250° C. and subsequently half an hour at 0.18 mbar. The so obtained polymer was allowed to cool to room temperature. The polymer had an ηᵢₙₕ of 2.7 dl/g, a Tg at −60° C., a Tfl at 185° C., a G′20 of 3 MPa, a CS₂₀ of 6% and a CS₇₀ of 35%.

### EXAMPLE 9

Copolymers T6T6T-PTMO₂₉₀₀ were made from 6T6, a terephthalic acid derivate and PTMO₁₀₀₀. The 6T6 used for the synthesis was obtained as described in example 1 and was a washed 6T6 with a uniformity of 70% or a recrystallized 6T6 with a uniformity of 97%. The vessel, contained 6T6 (0.891 g, 4.0 mmol), PTMO₂₉₀₀ (13.566 g, 4.0 mmol), MPT (8.0 mmol), Irganox 1330 (0.2 g), catalyst solution (1 ml of 0.05M Ti(i-OC₃H₇)₄ in m-xylene) and 25 ml NMP.

The reaction mixture was heated to 120° C., kept at that temperature for 3 hours, then warmed in 1 hour to 250 and kept 2 h at 250. The pressure was then carefully reduced (P<20 mbar) and then further reduced (P<1 mbar) for 60 minutes. Finally, the vessel was allowed to cool to room temperature whilst maintaining the low pressure.

The results of these polymerizations are given in table 8.

TABLE 8
T6T6T-PTMO₂₉₀₀ starting from 6T6, PTMO₂₉₀₀ and MPT

| 6T6-uniformity | ηᵢₙₕ | T_{g} | T_{fl} | G′20 |
|---|---|---|---|---|
| (%) | (dl/g) | (° C.) | (° C.) | (MPa) |
| 70 | 1.6 | −70 | 200 | 11 |
| 97 | 2.5 | −70 | 221 | 18 |

### EXAMPLE 10

Copolymers T6T6T-PTMO₂₉₀₀ were made from PTMO₂₉₀₀, HMDA and DPT. The vessel, contained PTMO₂₉₀₀ (11.60 g, 4.0 mmol), HMDA (0.928 g, 8.0 mmol), DPT (3.82 g, 12.0 mmol), Irganox 1330 (0.12 g), catalyst solution (1.2 ml of 0.05M Ti(i-OC₃H₇)₄ in m-xylene) and 25 ml NMP. The reaction mixture was heated to 120° C., kept at that temperature for 2 hours, then warmed in 1 hour to 250° C., kept 2 h at 250° C. during which time most of the NMP distilled off. The pressure was then carefully reduced (P<20 mbar) to distill off the last NMP and then further reduced (P<1 mbar) for 60 minutes. Finally, the vessel was allowed to cool to room temperature whilst maintaining the low pressure. The so obtained polymer was an elastic solid which had an ηᵢₙₕ of 2.95, a T_{fl} of 243° C., a G′₂₀ of 9 MPa and a CS₂₀ of 12%

### EXAMPLE 11

Copolymers T6T6T-PTMO₂₉₀₀ were made from PTMO₂₉₀₀, HMDA, DPT and MPT. The vessel, contained PTMO₂₉₀₀ (11.60 g, 4.0 mmol), HMDA (0.928 g, 8.0 mmol), DPT (1.02 g, 4.0 mmol), MPT (2.05 g, 8.0 mmol), Irganox 1330 (0.12 g), catalyst solution (1 ml of 0.05M Ti(i-OC₃H₇)₄ in m-xylene) and 25 ml NMP. The reaction mixture was heated to 120° C., kept at that temperature for 2 hours, then warmed in 1 hour to 250° C., kept 2 h at 250° C. during which time most of the NMP distilled off. The pressure was then carefully reduced (P<20 mbar) to distill off the last NMP and then further reduced (P<1 mbar) for 60 minutes. Finally, the vessel was allowed to cool to room temperature whilst maintaining the low pressure. The so obtained polymer was an elastic solid which had an ηᵢₙₕ of 2.40, a T_{fl} of 207° C., a G′₂₀ of 10 MPa and a CS₂₀ of 12%.

### EXAMPLE 12

Copolymers T6T6T-PTMO₂₉₀₀ were made from PTMO₂₉₀₀, 6T6 and MPT with an unbalance of the PTMO₂₉₀₀ compound compared to the amide segments. The polymers were prepared as in Example 9 with a 6T6 having a uniformity of 97% and the results are presented in Table 9.

TABLE 9
T6T6T-PTMO₂₉₀₀ influence of unbalance of the PTMO concentration

| Excess PTMO | ηᵢₙₕ | T_{fl} | G′_{20°} | CS_{20°} |
|---|---|---|---|---|
| (%) | (dl/g) | (° C.) | (MPa) | (%) |
| 30% | 1.55 | 205 | 13 | 16 |
| 0% | 2.5 | 221 | 18 | 8 |
| −15% | 1.5 | 237 | 27 | 10 |
| −30% | 1.15 | 256 | 35 | 12 |

An unbalance of reactance results as expected in a lower solution viscosity, this both for overfeed and underfeed PTMO. Surprisingly however is that while the overfeed PTMO material has a lower T_{fl} and G′_{20° C.} and a considerable higher CS_{20° C.}, the underfeed PTMO have considerable higher T_{fl} and G′_{20° C.} and the CS_{20° C.} only a little higher. With a PTMO underfeed a low viscosity system is obtained with an excellent combination of properties.

### EXAMPLE 13

Copolymers T6T6T-(PEO₆₀₀-T)x were made from polyethylene oxide (PEO) with a molecular weight of 600 g/mol, 6T6 and MPT. An example is given for T6T6T-(PE₆₀₀-T)₂₅₀₀₀₀. The vessel, contained PEO with a molecular weight of 600 (10.82 g, 18.03 mmol), 6T6 (with a uniformity of 97%) (1.81 g, 5.0 mmol), MPT (5.90 g, 23.03 mmol), Irganox 1330 (0.11 g), catalyst solution (1.8 ml of 0.05M Ti(i-OC₃H₇)₄ in m-xylene) and 25 ml NMP.

The reaction mixture was heated to 120° C., kept at that temperature for 3 hours, then warmed in 1 hour to 250° C. and kept 2 h at 250° C. The pressure was then carefully reduced (P<20 mbar) and then further reduced (P<1 mbar) for 60 minutes. Finally, the vessel was allowed to cool to room temperature whilst maintaining the low pressure. The results of these polymerisations are given in Table 10.

TABLE 10
T6T6T-(PEO₆₀₀-T)x polymers

| | | | | | | Contact |
|---|---|---|---|---|---|---|
| (PEO₆₀₀-T)x | ηᵢₙₕ | G' | T_{fl} | CS_{20°} | Water uptake* | angle** |
| (g/mol) | (g/dl) | (MPa) | (° C.) | (%) | (%) | (°) |
| 600 | 1.37 | 159 | 216 | 34 | 17 | 35 |
| 1250 | 1.90 | 68 | 208 | 23 | 35 | 36 |
| 2500 | 1.74 | 32 | 190 | 15 | 50 | 33 |
| 5000 | 2.38 | 12 | 170 | 10 | 66 | 30 |
| 10000 | 1.25 | 5 | 147 | — | 80 | 32 |

*after 1 month in water at 20° C.
**Contact angles were determined in demineralized water using the captive bubble technique on a Contact Angle System OCA15 plus from Data Systems.

The T6T6T-PEO polymers have all a low contact angle and this combined with good mechanical properties. These properties are important for membrane applications (like for breathing films) and where hydrophilic surfaces, are important like in biomaterials.

1. Copolymer, represented by formula I
—(—Y-AMIDE-(R-AMIDE-)N—)M- (I)
wherein each Amide represents an —N(H)C(O)— or an —C(O)N(H)— group,
wherein each R is independently chosen from the group consisting of alkylene moieties, alicyclic moieties and arylene moieties,
wherein n has an average value of at least 2,
wherein m has a value of at least 1,
wherein at least 30 mol % of the AMIDE-(R-AMIDE-)N segments are uniform in length,
wherein each Y represents a chain segment,
wherein the glass transition temperature of the polymer is below 0° C.
wherein the amide is from an aliphatic or alicyclic amine,
wherein the compression set (%) is less than (10+0.5×Shear Modulus (MPa)),
wherein the tensile set (%) is less than (30×log (Shear Modulus (MPa))+0.2).

2. Copolymer according to claim 1 wherein at least 50%, preferably at least 70%, of the AMIDE-(R-AMIDE-)n segments are uniform in length.

3. Copolymer according to claim 1, wherein the amide segments AMIDE-(R-AMIDE-)n are chosen from the group consisting of
—C(O)N(H)—R2-N(H)C(O)—R3-N(H)C(O)—;
N(H)C(O)—RL-C(O)N(H)—R3-C(O)N(H)—;
—C(O)N(H)—R2-N(H)C(O)—R1-C(O)N(H)—R2-N(H)C(O)—;
—C(O)N(H)—R3-C(O)N(H)—R2-N(H)C(O)—R3-N(H)C(O)—;
N(H)C(0)—RI-C(O)N(H)—R2-N(H)C(O)—RL-C(O)N(H)—; and
N(H)C(O)—R3-N(H)C(O)—R1-C(O)N(H)—R3-C(O)N(H)—,
wherein each R1 is independently chosen from the group consisting of alkylene moieties, alicyclic moieties and arylene moieties.

4. Copolymer according to claim 3, wherein each R1 are independently chosen from the group consisting of C1-C2O alkylene moieties, C4-C2O alicyclic moieties and C6-C20 arylene moieties, preferably consisting of adipic acid residues, terephthalic acid residues, ISOPHTHALIC acid residues and naphthalic acid residues.

5. Copolymer according to claim 4, wherein each R2 and/or R3 is independently chosen from the group consisting of C2-CS alkylene moieties and C6-C12 alicyclic moieties, which alkylene and/or alicyclic moieties optionally contain arylene groups.

6. Copolymer according to claim 1, wherein Y represents a chain segment with a molecular weight in the range of 200-40,000 g/mol, preferably in the range of 500-20,000 g/mol, more preferably in the range of 1,000-20,000 g/mol.

7. Copolymer according to claim 1, wherein Y represents a chain segment with a molecular weight of more than 4000 g/mol.

8. Copolymer according to claim 1, wherein the average value of n is at least about 3.

9. Copolymer according to claim 1, wherein at least one chain segment Y is a diacid chain segment made of an acid end modified aliphatic, aromatic, or partially aromatic polymeric segment, wherein the polymeric segment is a polyolefin, polyether, polyester, polycarbonate, polyacrylate, polystyrene or a copolymeric segment comprising moieties selected from the group consisting of olefin moieties, ether moieties, ester moieties, carbonate moieties, acrylate moieties and styrene moieties. If the polymeric segment contain hydroxyl groups than these segments can be reacted with a diacid or diacid derivative to a diacid chain segment.

10. Copolymer according to claim 1, wherein at least one chain segment Y is a diamine chain segment made of an amine end modified aliphatic, aromatic, or partially aromatic polymeric segment, wherein the polymeric segment is a polyolefin, polyether, polyester, polycarbonate, polysiloxane, polysilane, polyacrylate, polystyrene or a copolymeric segment comprising moieties selected from the group consisting of olefin moieties, ether moieties, ester moieties, carbonate moieties, siloxane moieties, silane moieties, acrylate moieties and styrene moieties.

11. Copolymer according to claim 1, comprising a chain segment Y that is a polymer segment which is extended with an ester, polyester, carbonate, polycarbonate, epoxy, polyepoxy, imide or polyimide.

12. Copolymer according to claim 1, wherein Y is a copolymer of a flexible chain segment and a polyester, polyurethane and/or polyurea.

13. Copolymer according to claim 1, wherein polymer segment in Y is extended with a terephthalate, isophthalate, adipate, naphthalate unit, poly (ethylene terephthalate) and poly (butylene terephthalate) or a combination thereof.

14. Copolymer according to claim 12, wherein the flexible chain segment is a poly (tetramethylene oxide), poly (propylene oxide), poly (ethylene oxide), poly (tetramethylene adipate), polycarbonate, poly (ETHYLENE/BUTYLENE), poly (dimethylsiloxane), polycarbonate or polyolefin.

15. Copolymer according to claim 1, wherein m is at least 2, preferably at least 3.

16. Copolymer according to claim 1, wherein the glass transition temperature of the polymer is less THAN −30° C.

17. Copolymer according to claim 1, wherein the melting temperature of the polymer is at least 130° C., preferably at least 180° C.

18. Copolymer according to claim 1, having a shear modulus at 20° C. of less than 500 MPa.

19. Copolymer according to claim 18, wherein the shear modulus at 20° C. is less than 250 MPa.

20. Copolymer according to claim 19, wherein the shear modulus at 20° C. is less than 40 MPa.

21. Copolymer according to claim 1, which copolymer has an onset of crystallization of 50° C. or less below its peak melting temperature (as measured in a differential scanning calorimeter at a scan rate of 20° C. per minute) upon cooling from a melt of said polymer, preferable less than 40° C., more preferably-less than 30° C.

22. Copolymer according to claim 1 wherein the mol amount of Y segment is lower than the amide segment, preferably at least 5%, more preferably at least 10% and most preferably more than 25% 23.

23. Composition comprising a copolymer according to claim 1 and an oil.

24. Blend comprising a copolymer according to claim 1 and one or more other polymers.

25. Blend according to claim 24, comprising one or more other polymers selected from the group consisting of polyamides, polyesters, polyesterethers, polyethylene, polypropylene, polyurethanes, polyureas, polycarbonate, polystyrene, polyacetal, polycarbonate, poly (phenylene ether), SBS, SEBScopolymers, PP-EPDM/EPR, PP-EPDM/EPR dynamic vulcanizates, rubbers, copolymers of these polymers and blends of these polymers.

26. Fiber comprising a copolymer according to claim 1.

27. Biocompatible material comprising a copolymer according to claim 1.

28. Injection moulding and/or extrusion material comprising a copolymer according to claim 1.

29. A (hot melt) adhesive material comprising a copolymer according to claim 1.

30. Breathable film material comprising a copolymer according to claim 1.

31. Composite comprising a copolymer according to claim 1 and at least one type of reinforcing fillers.

32. Composite according to claim 31, comprising one or more reinforcing fillers selected from the group consisting of mica, kaolin, calcium carbonate, glass fiber, aramide fiber and carbon fiber.

33. Method for preparing a copolymer according to claim 1, wherein the amide segments are prepared from dicarboxylic acid moieties, diamine moieties and/or amino acid moieties by melt polymerization.
